(19) United States
(12) Patent Application Publication
(10) Pub. No.: US 2026/0205021 A1
(43) Pub. Date: Jul. 16, 2026

(54) BIDIRECTIONAL CONVERTER

(71) Applicant: SHENZHEN GOSPELL DIGITAL TECHNOLOGY CO., LTD, Shenzhen (CN)

(72) Inventors: Jianhua Wu, Shenzhen (CN); Ping Liu, Shenzhen (CN)

(21) Appl. No.: 19/021,952

(22) Filed: Jan. 15, 2025

(51) Int. Cl. H02M 3/335; H02M 3/00

(52) U.S. Cl. CPC H02M 3/33584; H02M 3/003

(57) ABSTRACT

The present disclosure belongs to the technical field of power electronics and discloses a bidirectional converter. The bidirectional converter includes a capacitor C5, wherein one terminal of the capacitor C5 is connected to one terminal of an inductor L1, the other terminal of the inductor L1 is connected to a drain of an MOS transistor Q1 and one terminal of a capacitor C1, the other terminal of the capacitor C1 is connected to a pin 1 of a transformer T, and the other terminal of the capacitor C5 is connected to one terminal of a capacitor C6, a source of the MOS transistor Q1, a drain of an MOS transistor Q2, a pin 2 of the transformer T, and a pin 3 of the transformer T. The present disclosure has the following beneficial effects: in an application scenario where a high voltage is input or output, the circuit can realize isolated bidirectional conversion with a relatively low voltage-withstanding switching transistor, coupled inductors reduce input and output ripple currents, and by using a midpoint tapped transformer, input and output can realize automatic midpoint balance, so that the circuit can serve as a direct current circuit at the midpoint of an isolation belt of a three-level inverse DC/AC.

### TECHNICAL FIELD

The present disclosure relates to the technical field of power electronics, and particularly relates to a bidirectional converter.

### BACKGROUND

A converter converts electric energy in one form into electric energy in another form suitable for requirements in a usage scenario, for example, interconversion between alternating current and direct current and between direct current and direct current to meet different application requirements. To simplify the design, reduce the conversion link, reduce the loss, and improve the overall efficiency, a unidirectional converter is gradually transformed into a bidirectional converter. An AC/DC converter is a circuit that converts an alternating current into a direct current, and its power flow direction may be bidirectional. A power flow flowing from a power supply to a load is called rectification and a power flow returning from the load to the power supply is called active inversion. In actual application, there are also other bidirectional converters. In an existing circuit, some bidirectional converters are complex in structure and high in cost; and some bidirectional converters are simple in structure and lower in cost but the application range of such bidirectional converters is limited, and the circuit will be unstable if the bidirectional converters exceed a certain range.

Therefore, it is necessary to provide a bidirectional converter that is simple in structure and stable in operation, and facilitates a miniaturized design.

### BRIEF SUMMARY OF THE INVENTION

The present disclosure discloses a bidirectional converter, which can solve the technical problems involved in the background art.

In order to achieve the above objective, the present disclosure adopts the following technical solution:

A bidirectional converter, including a capacitor C5, where one terminal of the capacitor C5 is connected to one terminal of an inductor L1, the other terminal of the inductor L1 is connected to a drain of an MOS transistor Q1 and one terminal of a capacitor C1, the other terminal of the capacitor C1 is connected to a pin 1 of a transformer T, the other terminal of the capacitor C5 is connected to one terminal of a capacitor C6, a source of the MOS transistor Q1, a drain of an MOS transistor Q2, a pin 2 of the transformer T, and a pin 3 of the transformer T, the other terminal of the capacitor C6 is connected to one terminal of an inductor L2, the other terminal of the inductor L2 is connected to a source of the MOS transistor Q2 and one terminal of the capacitor C2, and the other terminal of the capacitor C2 is connected to a pin 4 of the transformer T; a pin 5 of the transformer T is connected to one terminal of a capacitor C4, the other terminal of the capacitor C4 is connected to a source of an MOS transistor Q4 and one terminal of an inductor L4, the other terminal of the inductor L4 is connected to one terminal of a capacitor C8, a pin 6 of the transformer T is connected to a pin 7 of the transformer T, a drain of the MOS transistor Q4, a source of the MOS transistor Q3, the other terminal of the capacitor C8, and one terminal of the capacitor C7, a pin 8 of the transformer T is connected to one terminal of the capacitor C3, the other terminal of the capacitor C3 is connected to the drain of the MOS transistor Q3 and one terminal of an inductor L3, and the other terminal of the inductor L3 is connected to the other terminal of the capacitor C7.

As a preferred improvement of the present disclosure, one terminal of the capacitor C5 and the other terminal of the capacitor C6 are connected to a power supply, and the other terminal of the capacitor C7 and one terminal of the capacitor C8 are connected to a load.

As a preferred improvement of the present disclosure, the transformer T is a midpoint tapped transformer, the pin 2 and the pin 3 of the transformer T are primary side midpoints, and the pin 6 and the pin 7 of the transformer T are secondary side midpoints.

As a preferred improvement of the present disclosure, the pin 1 and the pin 2 of the transformer T share one coil, the pin 3 and the pin 4 of the transformer share one coil, the pin 5 and the pin 6 of the transformer T share one coil, and the pin 7 and the pin 8 of the transformer T share one coil.

As a preferred improvement of the present disclosure, gates of the MOS transistor Q1, the MOS transistor Q2, the MOS transistor Q3, and the MOS transistor Q4 are all connected to an MCU.

As a preferred improvement of the present disclosure, the inductor L1 and the inductor L2 are coupled inductors, the inductor L3 and the inductor L4 are coupled inductors, one terminal of the inductor L1 and one terminal of the inductor L3 are dotted terminals, and the other terminal of the inductor L2 and the other terminal of the inductor L4 are dotted terminals.

As a preferred improvement of the present disclosure, the pin 6 of the transformer T is connected to the drain of the MOS transistor Q4 and the other terminal of the capacitor C8 and is connected to the other terminal of the inductor L3 and the other terminal of the capacitor C7 through a switch S1, the pin 7 of the transformer T is connected to the drain of the MOS transistor Q3 and one terminal of the capacitor C7 and is connected to the pin 6 of the transformer T through a switch S2, and one terminal of the capacitor C8 is connected to the pin 7 of the transformer T through a switch S3.

The present disclosure has the beneficial effects as follows:

In an application scenario where a high voltage is input or output, the circuit can realize isolated bidirectional conversion with a relatively low voltage-withstanding switching transistor. The bidirectional conversion in a wide voltage range improves the utilization ratio of an inductance core, and facilitates a miniaturized design.

### BRIEF DESCRIPTION OF THE SEVERAL VIEWS OF THE DRAWINGS

In order to describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative labor.

FIG. 1 is a circuit diagram of an existing converter;

FIG. 2 is a schematic diagram of a bidirectional converter according to the present disclosure;

FIG. 3 is a schematic circuit diagram I according to the present disclosure;

FIG. 4 is a schematic circuit diagram II according to the present disclosure; and

FIG. 5 is a schematic diagram according to embodiment I of the present disclosure.

### DETAILED DESCRIPTION OF THE INVENTION

The technical solution in embodiments of the present disclosure will be clearly and completely described below with reference to the embodiments of the present disclosure. Apparently, the described embodiments are merely a part, rather than all of the embodiments, of the present disclosure. On the basis of the embodiments in the present disclosure, all other embodiments acquired by those of ordinary skill in the art without creative labor also fall within the scope of protection of the present disclosure.

It is to be noted that all directional indications (for example, upper, lower, left, right, front, back, and the like) in the embodiments of the present disclosure are merely used for explaining relative position relations, moving conditions, and the like among components in a certain special gesture (as shown in the drawings). If the special gesture changes, the directional indications will change correspondingly.

In addition, the descriptions such as “first” and “second” are merely used for a description purpose rather than being construed as indicating or implying relative importance or implicitly indicating the quantity of indicated technical features. Thus, features defined by “first” and “second” may expressively or implicitly indicate the inclusion of at least one said feature. In the description of the present disclosure, unless otherwise specified, “a plurality of” means at least two, for example, two, three, and the like.

In the present disclosure, unless otherwise specified and defined, the terms “connect”, “fix”, and the like shall be understood in a broad sense. For example, “fix” can be fixedly connection or detachable connection or integrated connection; mechanical connection or electrical connection; or direct connection or indirect connection through an intermedium, and internal communication of two components or an interactive relationship of the two components, unless otherwise defined. Those of ordinary skill in the art may understand the specific meanings of the terms in the present disclosure under specific circumstances.

In addition, the technical solutions of the embodiments of the present disclosure may be combined with one another based on implementation by those of ordinary skill in the art. When the technical solutions contradict each other in combination or may not be realized, it is to be considered that there is no combination of the technical solutions, which shall not fall into the protection scope of the present disclosure.

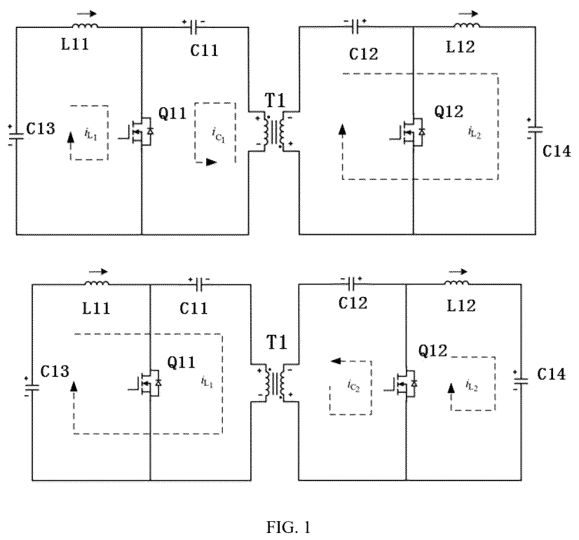

Referring to FIG. 1, FIG. 1 illustrates a converter circuit, where C13 serves as an input filter capacitor and C14 serves as an output filter capacitor. A steady state working process is as follows: when Q11 is switched on and Q12 is switched off, a current of an inductor L11 rises, a capacitor C11 is connected to a primary side of a transformer T1 in parallel, and a voltage of the capacitor C11 is superposed with a voltage of a capacitor C12 through the transformer T1 and is filtered by L12 and C14 to supply power to a load. When Q11 is switched off, a current of the inductor L11 declines. In this case, an inductance voltage is converted, and the voltage of the primary side of the transformer T1 rises from the negative maximum value to the positive maximum value. A body diode of Q12 is in positively biased conduction, and in this case, Q12 and L12 are switched on to enter a follow current stage. The current declines, and the voltage is converted to charge C14 continuously. V_{C14}=−L12dL12/dt. Vs is the voltage of a secondary side of the transformer, and when Vs+V_{C12}−V_{C14} declines to zero and becomes negative, the current of the inductor L12 starts to decline from the maximum value. When the current of the inductor L12 is close to zero, Q11 is switched on, the current of the inductor L12 starts to rise, and the turn ratio of the transformer is equal to 1:n. When Q11 is switched off, since the current of the inductor L11 declines, voltages at both terminals thereof are converted. The voltage stress at both terminals of the switching transistor is V_{C13}−L11di_{L11}/dt, which is greater than an input voltage V_{C13}. When Q12 is switched off, the voltage stress at both terminals is Vc₁₄+L12di_{L12}/dt, which is greater than an output voltage V_{C14}. When the switching transistors Q11 and Q12 are switched off, the voltage stress is greater than the input voltage and the output voltage. An isolated direct current output or an output cannot be connected directly with DC/AC of a common three-level inverter circuit.

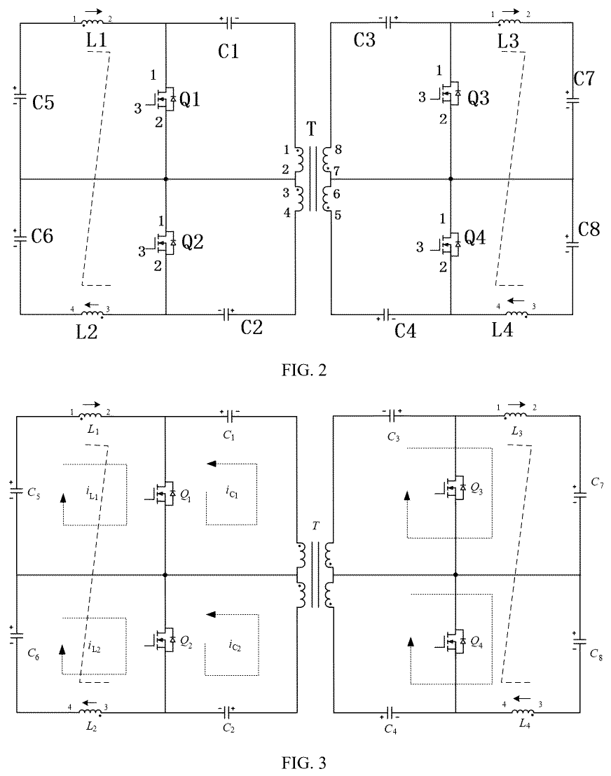

Referring to FIG. 2, based on the problem in FIG. 1, the present disclosure provides a bidirectional converter. In an application scenario where a high voltage is input or output, the circuit can realize isolated bidirectional conversion with a relatively low voltage-withstanding switching transistor. The converter includes a capacitor C5, where one terminal of the capacitor C5 is connected to one terminal of an inductor L1, the other terminal of the inductor L1 is connected to a drain of an MOS transistor Q1 and one terminal of a capacitor C1, the other terminal of the capacitor C1 is connected to a pin 1 of a transformer T, the other terminal of the capacitor C5 is connected to one terminal of a capacitor C6, a source of the MOS transistor Q1, a drain of an MOS transistor Q2, a pin 2 of the transformer T, and a pin 3 of the transformer T, the other terminal of the capacitor C6 is connected to one terminal of an inductor L2, the other terminal of the inductor L2 is connected to a source of the MOS transistor Q2 and one terminal of the capacitor C2, and the other terminal of the capacitor C2 is connected to a pin 4 of the transformer T; a pin 5 of the transformer T is connected to one terminal of a capacitor C4, the other terminal of the capacitor C4 is connected to a source of an MOS transistor Q4 and one terminal of an inductor L4, the other terminal of the inductor L4 is connected to one terminal of a capacitor C8, a pin 6 of the transformer T is connected to a pin 7 of the transformer T, a drain of the MOS transistor Q4, a source of the MOS transistor Q3, the other terminal of the capacitor C8, and one terminal of the capacitor C7, a pin 8 of the transformer T is connected to one terminal of the capacitor C3, the other terminal of the capacitor C3 is connected to the drain of the MOS transistor Q3 and one terminal of the inductor L3, and the other terminal of the inductor L3 is connected to the other terminal of the capacitor C7. In the embodiment, one terminal of the capacitor C5 and the other terminal of the capacitor C6 are connected to a power supply, and the other terminal of the capacitor C7 and one terminal of the capacitor C8 are connected to a load. Gates of the MOS transistor Q1, the MOS transistor Q2, the MOS transistor Q3, and the MOS transistor Q4 are all connected to an MCU. The inductor L1 and the inductor L2 are coupled inductors, the inductor L3 and the inductor L4 are coupled inductors, one terminal of the inductor L1 and one terminal of the inductor L3 are dotted terminals, and the other terminal of the inductor L2 and the other terminal of the inductor L4 are dotted terminals.

As an implementation, the transformer T is a midpoint tapped transformer, the pin 2 and the pin 3 of the transformer T are primary side midpoints, and the pin 6 and the pin 7 of the transformer T are secondary side midpoints. Or, the pin 1 and the pin 2 of the transformer T share one coil, the pin 3 and the pin 4 of the transformer share one coil, the pin 5 and the pin 6 of the transformer T share one coil, and the pin 7 and the pin 8 of the transformer T share one coil. It shall be further noted that solutions that achieve the above effect by using other components shall fall within the inventive concept of the present disclosure and shall fall within the scope of protection of the present disclosure.

A working principle is as follows:

When Q1 and Q2 are switched on simultaneously, the currents of the inductors L1 and L2 rise. The capacitors C1 and C2 are connected to the primary side of the transformer in parallel, and the voltages of the capacitors C1 and C2 are superposed with the voltages of the capacitors C3 and C4 through the transformer T. The voltage is filtered by L3, C7, L4, and C8 to supply power to the load. The voltage stress of the Q3 and Q4 is V_{Q3DS}+V_{Q4DS}=L3di_{L3}/dt+L4di_{L4}/dt−V_{C7}−V_{C8}.

The inductors L1 and L2, and the inductors L3 and L4 are coupled inductors, with dotted terminals shown in FIG. 2. When the Q1 and Q2 are switched on simultaneously, the currents of the inductors L1, L2, L3, and L4 rise, and due to a coupling reason, ripple currents in the inductors decline. The voltage stress of the Q4 is V_{Q3DS}+V_{Q4DS}=L3di_{L3}/dt+L4di_{L4}/dt−V_{C7}−V_{C8}.

Since the mean voltage of the inductors and the transformer is zero, V_{C1}=V_{C5}, V_{C6}=V_{C2}, V_{C3}=V_{C7}, and V_{C4}=V_{C8}. If V_{C7} and V_{C8} deviate, the transformer with a center tap will balance the voltage deviation automatically to realize voltage balance. Thus, it is connected to the three-level DC/AC inverter circuit to realize single-phase, nematic-phase, and three-phase alternating current inversion, which is adapted to an alternating current unbalanced load.

### Embodiment I

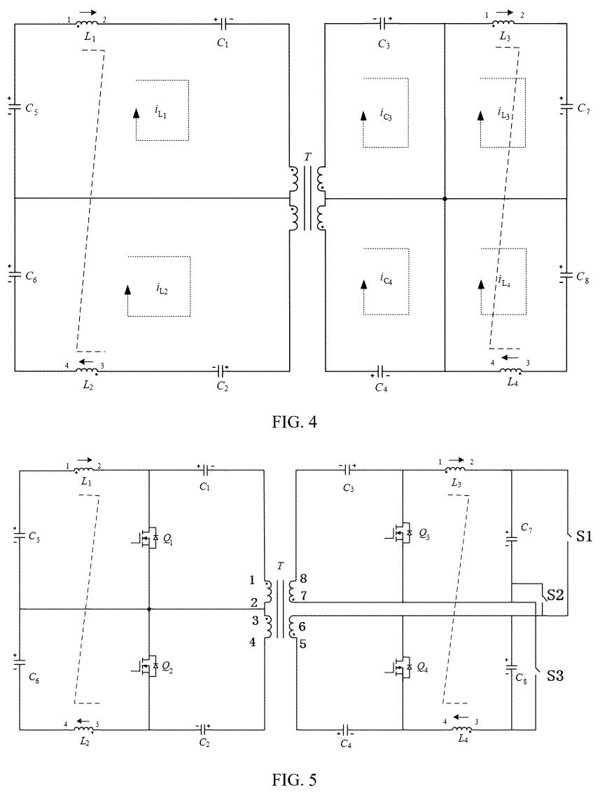

Series and parallel switching is shown in FIG. 5.

When S1 and S2 are switched on and S3 is switched off, the outputs of C7 and C8 are connected in parallel. When S1 and S2 are switched off and S3 is switched on, the outputs of C7 and C8 are connected in series. When Q1 and Q2 are switched on, the currents of the inductors L1 and L2 rise. The voltages of the capacitors C1 and C2 are superposed with voltages of C3 and C4 through the transformer to supply power to the load through the inductors L3 and L4 and the capacitors C7 and C8. When Q1 and Q2 are switched off, the currents of the inductors L1 and L2 decline, and the capacitors C1 and C2 are charged. The body diodes of Q1 and Q2 are switched on to output a follow current of the circuit.

In an application scenario where a high voltage is input or output, the circuit can realize isolated bidirectional conversion with a relatively low voltage-withstanding switching transistor, coupled inductors reduce input and output ripple currents, and by using a midpoint tapped transformer, input and output can realize automatic midpoint balance, so that the circuit can serve as a direct current circuit at the midpoint of an isolation belt of a three-level inverse DC/AC.

Although the embodiments of the present disclosure have been disclosed above, the present disclosure is not merely limited to applications listed in the description and the embodiments and can be completely applied to various fields suitable for the present disclosure. Those skilled in the art can easily achieve additional modifications. Therefore, the present disclosure is not limited to specific details and drawings described herein without deviating from a general concept defined by the claims and the equivalent scope.

What is claimed is:

1. A bidirectional converter, comprising a capacitor C5, wherein one terminal of the capacitor C5 is connected to one terminal of an inductor L1, the other terminal of the inductor L1 is connected to a drain of an MOS transistor Q1 and one terminal of a capacitor C1, the other terminal of the capacitor C1 is connected to a pin 1 of a transformer T, the other terminal of the capacitor C5 is connected to one terminal of a capacitor C6, a source of the MOS transistor Q1, a drain of an MOS transistor Q2, a pin 2 of the transformer T, and a pin 3 of the transformer T, the other terminal of the capacitor C6 is connected to one terminal of an inductor L2, the other terminal of the inductor L2 is connected to a source of the MOS transistor Q2 and one terminal of the capacitor C2, and the other terminal of the capacitor C2 is connected to a pin 4 of the transformer T;
a pin 5 of the transformer T is connected to one terminal of a capacitor C4, the other terminal of the capacitor C4 is connected to a source of an MOS transistor Q4 and one terminal of an inductor L4, the other terminal of the inductor L4 is connected to one terminal of a capacitor C8, a pin 6 of the transformer T is connected to a pin 7 of the transformer T, a drain of the MOS transistor Q4, a source of the MOS transistor Q3, the other terminal of the capacitor C8, and one terminal of the capacitor C7, a pin 8 of the transformer T is connected to one terminal of the capacitor C3, the other terminal of the capacitor C3 is connected to the drain of the MOS transistor Q3 and one terminal of an inductor L3, and the other terminal of the inductor L3 is connected to the other terminal of the capacitor C7.

2. The bidirectional converter according to claim 1, wherein one terminal of the capacitor C5 and the other terminal of the capacitor C6 are connected to a power supply, and the other terminal of the capacitor C7 and one terminal of the capacitor C8 are connected to a load.

3. The bidirectional converter according to claim 1, wherein the transformer T is a midpoint tapped transformer, the pin 2 and the pin 3 of the transformer T are primary side midpoints, and the pin 6 and the pin 7 of the transformer T are secondary side midpoints.

4. The bidirectional converter according to claim 1, wherein the pin 1 and the pin 2 of the transformer T share one coil, the pin 3 and the pin 4 of the transformer share one coil, the pin 5 and the pin 6 of the transformer T share one coil, and the pin 7 and the pin 8 of the transformer T share one coil.

5. The bidirectional converter according to claim 1, wherein gates of the MOS transistor Q1, the MOS transistor Q2, the MOS transistor Q3, and the MOS transistor Q4 are all connected to an MCU.

6. The bidirectional converter according to claim 1, wherein the inductor L1 and the inductor L2 are coupled inductors, the inductor L3 and the inductor L4 are coupled inductors, one terminal of the inductor L1 and one terminal of the inductor L3 are dotted terminals, and the other terminal of the inductor L2 and the other terminal of the inductor L4 are dotted terminals.

7. The bidirectional converter according to claim 1, wherein the pin 6 of the transformer T is connected to the drain of the MOS transistor Q4 and the other terminal of the capacitor C8 and is connected to the other terminal of the inductor L3 and the other terminal of the capacitor C7 through a switch S1, the pin 7 of the transformer 7 is connected to the drain of the MOS transistor Q3 and one terminal of the capacitor C7 and is connected to the pin 6 of the transformer T through a switch S2, and one terminal of the capacitor C8 is connected to the pin 7 of the transformer T through a switch S3.
